(19) United States
(12) Patent Application Publication
(10) Pub. No.: US 2021/0114560 A1
(43) Pub. Date: Apr. 22, 2021

(54) VEHICLE WINDSHIELD WIPER BLADE

(71) Applicant: Artur HIRSEKORN, Moscow (RU)

(72) Inventor: Artur HIRSEKORN, Moscow (RU)

(21) Appl. No.: 17/057,703

(22) PCT Filed: May 28, 2018
(86) PCT No.: PCT/RU2018/000342

§ 371 Date: Nov. 23, 2020

(51) Int. Cl. B60S 1/38

(52) U.S. Cl. CPC B60S 1/3886

(57) ABSTRACT

This invention relates to tape of glass cleaning brushes, mainly to automobile windscreen wipers, and can be used universally for efficient cleaning of the windscreen of a motor vehicle in any weather conditions.

The windscreen cleaning brush tape is made of an elastomeric material that can be firmly, without any gaps and installed motionless in the holder, while an axisymmetric cavity, triangular in its cross-section, runs along the entire length of the tape through the body of the scraper above its stretched out portion, and the sides of the triangular cavity run parallel to the sides of the scraper, forming sidewalls of the scraper. In another claim of this invention, the base of the triangular cavity carries at least one longitudinal symmetric rib, the vertex of which is directed towards the contacting portion of the scraper. Geometry and quantity of longitudinal ribs inside the cavity may vary. Also, the cleaning edge carries an axisymmetric longitudinal notch of triangular cross-section, which forms two symmetrically protruding wedge-shaped edges, running along both longitudinal sides of the stretched out contacting portion of the scraper.

Higher efficiency of windscreen wipers motor vehicles at sub-zero temperatures is achieved. The offered tape for wipers is simple in structure and production method and is easy to use.

### STATE OF THE ART

This invention relates to tapes for wiper, designed mainly for motor vehicles, and it can be used universally for cleaning windscreens efficiently under any weather conditions.

### PRIOR ART

Wiper tape for motor vehicles, cars for example, used for efficient cleaning of windscreens from rain or snow, is usually manufactured of elastic, flexible material. Usually, it consists of a base fixed in the holder and a working component that presents a scraper with a cleaning edge on its contacting portion. The scraper is connected to the base with a connecting elastic component in such a fashion as to permit the working portion of the rubber tape, presenting a scraper with a cleaning edge, bend in one or the other direction, changing the angle with respect to the cross-axis of the base, depending which way the scraper moves on the glass surface. When the wiper is in operation, one of the butt ends of the rubber tape is always higher—in its ultimate, usually upper position—than the other end, or else both butt faces are located at the same level. The cross-section of the scraper usually presents an isosceles triangle, the base of which is located next to the flexible connecting component, while its vortex forms a stretched out cleaning edge. The base, working part (the scraper and its cleaning edge) and the flexible component that connects the base and working portion are manufactured as one piece.

General requirements to rubber tapes for the windscreen, in addition to high quality cleaning, are: high wear resistance and stability when exposed to adverse external influences (snow, glaciation), which can impair, often eliminate, efficiency of windscreen wipers.

A wiper with a tape for motor vehicle windscreen cleaning belongs to the category of mass-produced industrial consumer goods as they meet the needs of more than billion vehicles around the world, widely used in different climate zones. In some part of the world low temperatures stay for considerable periods of time, often exacerbated by snowfalls and icy rains.

Some known wiper tapes, used for cleaning windscreens—of snow specifically—are designed with an additional heating device, aimed at melting snow and/or ice accumulated on the tape and preventing its glaciation by heating the tape. Such is the wiper of patent DE10200834967 “Rubber Tape Windscreen”, which is equipped with an electric heating wire and/or cord, electric resistance of which decreases at low ambient temperatures, a cable for electric current transmission and links for the heating wire along the entire length of the rubber tape. This patent belongs to PRAGST WALTER (DE), MPC B60S1/38, published on Jan. 7, 2010. This patent suggests heating the rubber tape of a windscreen wiper when the vehicle has to operate in snowfall, preventing a crust of ice forming on the wiper. The rubber tape carries an electric heating wire or cord inside. However, using a rubber tape of this kind in snowfalls would reduce the economic effect of its application due to the need to have extra heating equipment, which, naturally, requires space, as well as maintenance, also replacement when necessary, etc.

There is a rubber tape of patent RU2269439 “Rubber Tape for a Wiper”, the patent owner being ROBERT BOSCH GMBH (DE), MPC B60S1/38, published on Oct. 2, 2006. This tape has a profiled base and a working portion, connected with the base via a flexible component, and the working portion leans on the base when it is located in a tilted position. The working portion has a support area connected to the profiled base by the means of the first flexible bridge, while it is connected to the wedge-shaped cleaning portion of the rubber tape by the second flexible bridge. This solution ensures that the wiper has proper contact with the glass surface. However, the protruding support areas on the rubber tape cause accumulation of freezing fluid or snow between the support areas and flexible bridges. Frozen fluid (water) and ice-crusted snow reduce effectiveness of this wiper at low temperatures.

The most common to the present invention in its technological essence are the widely known and used wiper rubber tapes of classical structure, described in the Internet magazine “Behind the Wheel”, in the article entitled “Windscreen Wipers” (http://wiki.zr.ru/ [symbol] [symbol] ).

The known tape presents a rubber strip with a complex cross-section, its base carrying notches for the holder frame (holder), a neck (a connecting component) and a working portion (a scraper) with a cleaning edge. The scraper of this tape has a wedge-shaped cross-section, while its cleaning edge, which is in contact with the glass, is of strictly rectangular shape with sharp edges. To use that tape in winter, when ambient temperatures fall below zero, the holder is covered with a shield made of thin and soft frost-resistant fabric. The only drawback of that arrangement is skidding. Even at relatively low speed (80-90 km/h), the contraflow of air can lift a wiper of this kind. It starts skidding on the glass surface, leaving uncleaned stripes, which reduces considerably their efficiency in winter.

### DESCRIPTION OF INVENTION

This invention aims at improving effectiveness of wipers for motor vehicles at sub-zero temperatures. This invention also aims at offering a wiper tape of simple structure, easy to manufacture and use.

The object of this invention is wiper tape for motor vehicles, characterized by a simple structure, simple to produce and use, with improved functional deformation during its operation, and of a design lacking any surface areas where freezing fluid (water) could accumulate, which makes these wipers suitable for work when ambient temperatures fall below zero.

This purpose is achieved by the wiper tape structure described in appended claims 1 and 4. The preferred features and appropriate modifications are presented in the dependent sub-claims of the invention.

The suggested wiper tape for motor vehicles is made of an elastic material and consists of a base suitable for fixing it in the holder, and a wedge-shaped scraper, the stretched-out contacting part of which carries a cleaning edge. The scraper is connected to the base via a connecting component. The tape can be tightly and fixedly installed in the holder. A through cavity runs in the centre of the body of the scraper along the entire length of the tape above its stretched-out part. The cavity has a triangular cross-section, while its base runs parallel to the base of the tape, and its sides run parallel to the sidewalls of the scraper, forming sidewalls of the scraper. The thickness of each sidewall of the scraper is proportional to the thickness of its stretched-out contacting part. The butt end of the tape that is up when the wiper is in operation carries a plug inserted in the through cavity in the scraper. The inner surface of the through cavity at the butt end of the tape that is down when the scraper is in operation is made hydrophobic.

According to another embodiment of the invention, the wiper tape is made of an elastic material and comprises a base that can be installed in the holder and a wedge-shaped scraper, the stretched-out portion of which carries a cleaning edge, while the scraper is connected with the base by the means of a connecting component. The tape can be tightly and fixedly installed in the holder. A through cavity runs in the centre of the body of the scraper along the entire length of the tape above its stretched-out part. The cavity has a triangular cross-section, its base being parallel to the base of the tape, while its sides being parallel to the sidewalls of the scraper, forming sidewalls of the scraper. Thickness of each sidewall of the scraper is proportional to the thickness of its stretched out contact portion. The base of the through triangular cavity carries along its entire length at least one inner symmetrical lengthwise rib, the vortex of which is directed towards the contacting part of the scraper. The cleaning edge—along the entire length of the scraper—carries a lengthwise, axisymmetric slot of a triangular cross-section that forms two symmetrically positioned, wedge-shaped, protruding edges, running along both lengthwise sides of the stretched out portion of the scraper. Plugs can be inserted in the through cavity in the scraper at the upper and lower butt ends of the tape. The tape can be manufactured with both its butt ends sealed. The inner angles of the triangular through cavity in the scraper can be rounded. The inner surface of the through cavity in the scraper can be made hydrophobic. The cleaning edge on the stretched out contacting portion of the scraper can have a rectangular shape.

The design in which the tape of the wiper is tightly, with no gaps, and fixedly installed in the holder, eliminating any protruding support areas or open slots, and when a through cavity inside the scraper, which allows walls of the scraper be flexible, ensuring stable bending (deformation) of the scraper during its operation, results in a simple to manufacture and use device, prevents hold-ups of snow or water, followed by water freezing on the surface of the tape, and as a consequence in improved efficiency of motor vehicle wipers at low ambient temperatures.

### BRIEF DESCRIPTION OF THE DRAWINGS

This invention and its benefits will become clearer with the following detailed description and figures. The figures do not exclude from the scope of this invention other structural decisions that result from usual and suggested modifications of these concrete structural designs.

FIG. 1(A): A cross-section of the scraper with a through triangular cavity in the scraper

FIG. 1(B): Extreme angle of the scraper with a through triangular cavity when the scraper is in operation

FIG. 2(A): A cross-section of the scraper with a lengthwise inner rib made in the base of the through cavity in the body of the scraper

FIG. 2(B): Extreme angle of the scraper with a triangular through cavity with an inner lengthwise rib made in the base of the through cavity in the body of the scraper when the scraper is in operation

FIGS. 3(A, B, and C): Some other possible designs of the lengthwise inner ribs made in the base of the through cavity

FIG. 4: General view of the tape of FIG. 1 with plugs installed.

### EMBODIMENTS OF THE PRESENT INVENTION

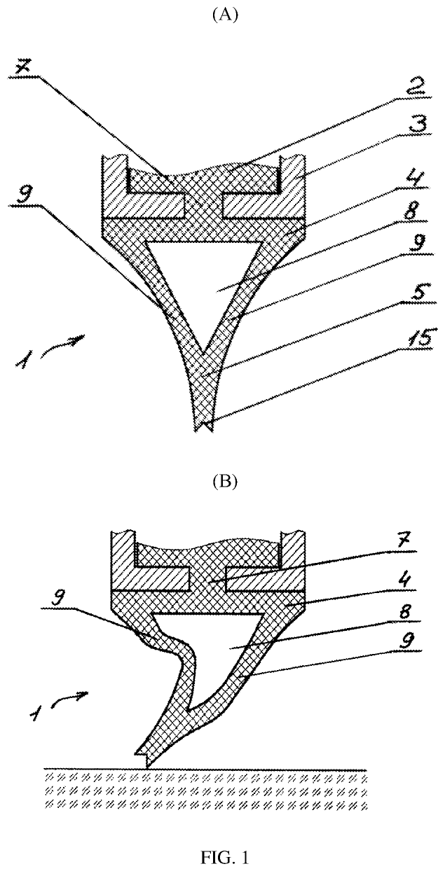

The embodiments suggested in this invention are presented below with references to the figures. Tape 1 (FIG. 1(A)) consists of the base 2, suitable to be fixed in the holder 3, and the wedge-shaped scraper 4 with the stretched out contacting part 5 that carries the cleaning edge 6. The scraper 4 is connected with the base 2 by the connecting component 7. The tape 1 is installed tightly, with no gaps, and fixedly in the holder 3. The triangular cavity 8 in the centre of the scraper, centred on its axis and running through the entire length of the tape above its stretched out part, forms the sidewalls 9 of the scraper 4. Thickness of each sidewall 9 of the scraper 4 is made proportional to the thickness of the stretched out part 5 of the scraper 4. The plug 14 can be inserted in the through cavity 8 of the rubber tape 1. The cleaning edge 6 has an axisymmetric lengthwise notch 15 of triangular cross-section that runs along the entire length of the scraper 4. This notch forms two symmetrically positioned wedge-shaped edges (not shown in the figures) that run along both lengthwise sidewalls of the stretched out contacting portion 5 of the scraper 4. This design of the cleaning edge 6 reduces its stiffness, improving its contact with the glass surface, especially where there are roughness, dimples, scratches or other surface defects, which significantly improves performance of the tape 1. This design of the cleaning edge 6 extends service life of the tape 1 because the vortex of each wedge-shaped edge retains its sharp angle for longer periods of time. The cleaning edge 6 of the stretched out portion 5 of the scraper 4 can be manufactured rectangular. The classical rectangular tape with sharp edges cleans of windscreens very efficiently.

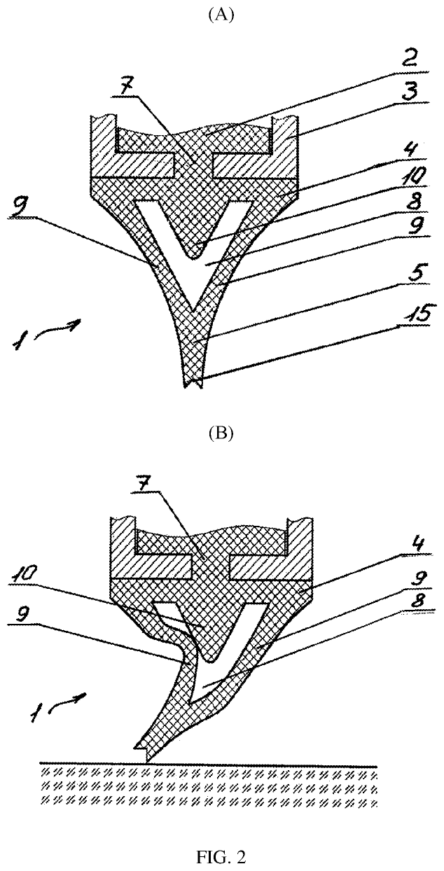

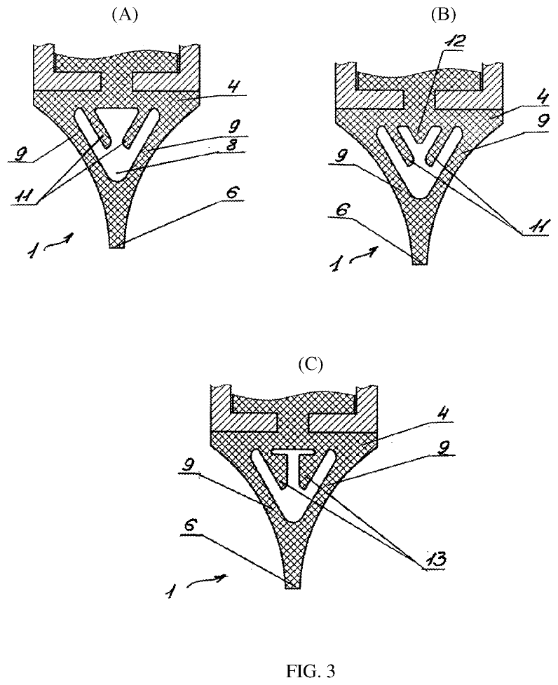

According to another embodiment (FIG. 2(A)) of this invention, the base of the through triangular cavity 8 of tape 1 carries at least one symmetrical, lengthwise rib 10, the vortex of which is directed towards the contacting portion 5 of the scraper 4. Geometry and number of inner lengthwise ribs in the cavity 8 of the scraper 4 may vary. FIGS. 3(A, B, and C) demonstrates some of the possible designs of the ribs, 11, 12, and 13 respectively. The inner corners of the through cavity 8 in the body of the scraper 4 can be rounded, which simplifies the rubber tape manufacture technology and thus simplifies its commercial production.

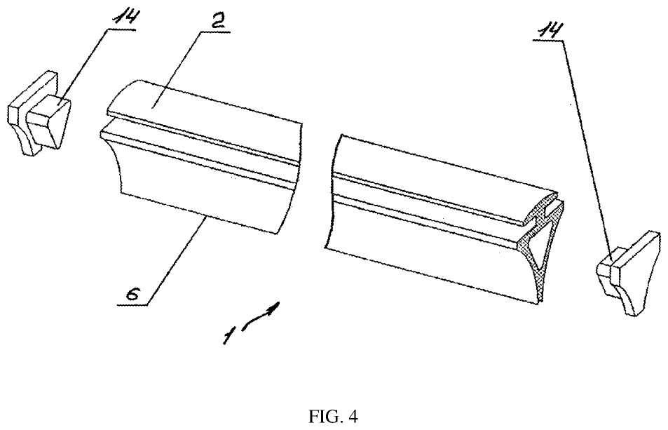

Wipers with rubber tapes 1 can be brought into swinging motion by the levers (arms) of the wiper when required to remove drops of water or snow from the windscreen. Consequently, one of the two butt surfaces of the tape 1 is constantly above the other butt in an ultimate, usually upper, position. A position when both butt surfaces of the tape are on the same level is possible. To prevent water droplets or snow entering the through cavity 8, it is possible to insert plugs 14 into the cavity, or else the entire surface of the cavity can be made hydrophobic. The plugs 14 can be inserted into the cavity 8 on both butts of the tape 1 (FIG. 4) or else both ends can be sealed. When there are no plugs on the butts of the tape, (the lower end is open), to minimize capillary effect and penetration of moisture into the through cavity 8, its inner surface can be made hydrophobic.

In the course of swinging, pendulum-like, motion, the wiper with tape 1 will reach its ultimate position where the motion changes its direction to the opposite. At these ultimate points the slope of the wedge-shaped scraper 4 of the tape 1 changes to opposite value with respect to the vertical to the glass surface, but then the previous working position of the wedge-shaped scraper 4 is re-established. As the tape 1 fits the holder 3 tightly, with no gaps, and fixedly, the connecting component 7 remains stationary during the cleaning process. The tight fit of the tape 1 in the holder 3 prevents accumulation of freezing fluid (water) on the tape, therefore considerably improving efficiency of the windscreen cleaning process at sub-zero temperatures. Elasticity of the sidewalls 9, formed by the walls of the triangular cavity 8 and the outer sides of the scraper 4, contribute to the capability of the scraper 4 bend during the working cycle as is shown in FIG. 1(B). When the plugs 14 are installed in the butts of the tape 1, or else when both ends of the tape 1 are sealed, gas—air for instance—pressure inside the cavity of the rubber tape 1 contributes to bending the scraper 4 during its operation. Air pressure inside the cavity is used as a pneumatic stiffening component. FIG. 2(B) shows an ultimate angle of the scraper 4 of the rubber tape 1, in its operating condition—with an inner lengthwise rib 10 made in the base of the triangular cavity in the scraper 4. When the scraper 4 bends during its working process, when the wiper swings, the sidewalls 9 of the scraper 4 press in turns against the lengthwise rib 10 in the base of the through cavity 8, which increases stiffness and prevents further undesirable increase of the slope angle of the scraper 4 in relation to the vertical to the glass surface.

FIGS. 3(A, B, and C) shows the embodiments with lengthwise ribs 11, 12, and 13 respectively in the cavity 8 in the scraper 4. These claims are not demonstrated in action. However, it is obvious that as the scraper bends during its work, the sidewalls 9 of the scraper 4 would press in turns against the inner ribs 11, increasing elastic resistance to any further increase of the deviation angle of the scraper 4 with respect to the vertical to the glass surface. If sidewalls 9 become excessively deformed inside the cavity 8, the lengthwise rib 11 would press against the central lengthwise rib 12, which would prevent its further deformation. Also, each sidewall 9 of the scraper 4 of the tape 1 would press against the nearest inner lengthwise rib 14, while if deformation of the sidewall 9 inside the cavity 8 of the scraper 4 continues, the profiled protuberance (not shown in the figures) of the scraper 14 would press against the base 2 of the tape 1, preventing further undesirable bending of the scraper 4.

Consequently, installing a tape tightly, with no gaps, and fixedly, in its holder prevents formation of areas of accumulation of iced-up fluid (water) on the tape, which makes a wiper more effective when working under sub-zero ambient conditions. It also simplifies the manufacturing process of such a tape. Having a through cavity in the scraper of the tape, possibly with inner lengthwise ribs, vouchers for a required stable bent of the scraper when cleaning the windscreen of a motor vehicle. This improves performance of a wiper on the whole.

1. Tape for the blade of a windscreen wiper for motor vehicles, made of an elastomeric material, comprising a base, suitable for being fixed in the holder and a wedge-shaped scraper, the stretched out portion of which carries a cleaning edge, while the scraper is connected with the base via a connecting component, different in that the tape can be tightly and fixedly installed in the holder, while an axisymmetric cavity of triangular crosswise section runs through the body of the scraper above its stretched out portion, while the base of the triangular cavity runs parallel to the base of the tape, and its sides run parallel to the sides of the scraper, thus forming sidewalls of the scraper, and the thickness of each sidewall of the scraper is proportional to the thickness of its stretched out portion; characterised in that, the cleaning edge carries, along the entire length of the scraper, an axisymmetric lengthwise notch of triangular crosswise section, which forms two symmetrically protruding wedge-shaped edges, running along both lengthwise sides of the stretched out contact portion of the scraper.

2. Tape according to claim 1, characterized in that there a plug is inserted in the butt end of the cavity that takes an upper position during the cleaning operation.

3. Tape according to claim 1, characterized in that the inner surface of the through running cavity in the centre of the scraper is made of a hydrophobic material at the butt end that is located at the bottom during the operation.

4. Tape for the blade of a windscreen wiper for motor vehicles, made of an elastomeric material, comprising a base, suitable for being fixed in the holder and a wedge-shaped scraper, the stretched out portion of which carries a cleaning edge, while the scraper is connected with the base by a connecting component, different in that the tape can be tightly and fixedly installed in the holder, while an axisymmetric cavity of triangular crosswise section runs through the body of the scraper above its stretched out portion, while the base of the triangular cavity runs parallel to the base of the tape, and its sides run parallel to the sides of the scraper, thus forming sidewalls of the scraper, and the thickness of each sidewall of the scraper is proportional to the thickness of its stretched out portion; characterised in that, the base of the cavity carries at least one symmetric, lengthwise rib, the apex of which is directed towards the contacting edge of the scraper, and also the cleaning edge carries, along the entire length of the scraper, an axisymmetric lengthwise notch of triangular crosswise section, which forms two symmetrically protruding wedge-shaped edges, running along both lengthwise sides of the stretched out contact portion of the scraper.

5. Tape according to the claim 1, characterized in that its upper and lower butt ends in the through running cavity in the scraper carry a plug each.

6. Tape according to the claim 1, characterized in that it is sealed at its upper and lower butts.

7. Tape according to the claim 1, characterized in that the inner corners of the triangular through-running hole in the scrapper are rounded.

8. Tape according to the claim 1, characterized in that the inner surface of the through running hole in the scraper is hydrophobic.

9. Tape according to claim 1, characterized in that the cleaning edge is rectangular in shape along the entire stretched out contacting portion of the scraper.

10. Tape according to the claim 4, characterized in that its upper and lower butt ends in the through running cavity in the scraper carry a plug each.

11. Tape according to the claim 4, characterized in that it is sealed at its upper and lower butts.

12. Tape according to the claim 4, characterized in that the inner corners of the triangular through-running hole in the scrapper are rounded.

13. Tape according to the claim 4, characterized in that the inner surface of the through running hole in the scraper is hydrophobic.
